(19) United States
(12) Patent Application Publication
(10) Pub. No.: US 2026/0362237 A1
(43) Pub. Date: Nov. 12, 2026

(54) ADAPTIVE PACKET PROCESSING BY A VIRTUAL NETWORK DEVICE

(71) Applicant: Juniper Networks, Inc., Sunnyvale, CA (US)

(72) Inventor: Lavanya Kumar Ambatipudi, Fremont, CA (US)

(21) Appl. No.: 19/205,584

(22) Filed: May 12, 2025

(51) Int. Cl. H04W 28/10

(52) U.S. Cl. CPC H04W 28/10

(57) ABSTRACT

In general, this disclosure describes techniques for using a cache of packet operations to improve packet processing. In an example, a virtual network device is executed by processing circuitry and is configured to, based on a determination that a second packet received by the virtual network device is associated with a packet flow, apply one or more packet operations for the packet flow to the second packet, wherein the one or more packet operations for the packet flow are stored to an operations database and determined by the virtual network device for the packet flow based on a prior application, by the virtual network device, of one or more packet processing stages to a first packet of the packet flow.

### TECHNICAL FIELD

The disclosure relates to network packet processing and, more specifically, to packet processing by a virtual network device.

### BACKGROUND

In a typical cloud data center environment, there is a large collection of interconnected servers that provide computing and/or storage capacity to run various applications. For example, a data center may comprise a facility that hosts applications and services for subscribers, i.e., customers of data center. The data center may, for example, host all of the infrastructure equipment, such as networking and storage systems, redundant power supplies, and environmental controls. In a typical data center, clusters of storage systems and application servers are interconnected via high-speed switch fabric provided by one or more tiers of physical network switches and routers. More sophisticated data centers provide infrastructure spread throughout the world with subscriber support equipment located in various physical hosting facilities.

Virtualized data centers are becoming a core foundation of the modern information technology (IT) infrastructure. In particular, modern data centers have extensively utilized virtualized environments in which virtual hosts, also referred to herein as virtual execution elements, such virtual machines or containers, are deployed and executed on an underlying compute platform of physical computing devices.

Virtualization within a data center can provide several advantages. One advantage is that virtualization can provide significant improvements to efficiency. As the underlying physical computing devices (i.e., servers) have become increasingly powerful with the advent of multicore microprocessor architectures with a large number of cores per physical CPU, virtualization becomes easier and more efficient. A second advantage is that virtualization provides significant control over the computing infrastructure. As physical computing resources become fungible resources, such as in a cloud-based computing environment, provisioning and management of the computing infrastructure becomes easier. Thus, enterprise IT staff often prefer virtualized compute clusters in data centers for their management advantages in addition to the efficiency and increased return on investment (ROI) that virtualization provides.

### SUMMARY

In general, this disclosure describes techniques for using a cache of packet operations to improve packet processing. The disclosed techniques include determining the operations performed for a packet associated with a given packet flow by observing operations performed as part of processing the packet. For example, a virtual network device may determine the operations performed in packet processing stages for a packet of a packet flow and store data indicating the operations in an operations cache for the packet flow. In some examples, the virtual network device may determine reduced packet operations from the operations performed by excluding certain categories of operations that do not contribute to packet processing for the packet flow. The reduced packet operations may include a comparatively reduced number of packet operations from those performed in the packet processing stages. In such examples, the virtual network device stores the reduced packet operations for the packet flow to the operations cache. For subsequent packets of the packet flow, the virtual network device processes the subsequent packet using the operations stored in the operations cache for the packet flow.

In some examples, determining and caching the packet operations for a packet flow is stage-based. The virtual network device applies a software-based packet processing pipeline that includes a plurality of stages that can be applied to packets of packet flows. Each of the stages applies zero or more operations to packets of a packet flow. The virtual network device learns, for each stage applied to a packet of a particular packet flow, the modifications performed on the packet and the outcome for the packet (e.g., drop or forward). The virtual network device stores, to the cache and for the packet flow, data indicating these modifications and outcome for at least for those stages of the pipeline that modify or affect a packet (e.g., with a drop or forward outcome). Such data for stages that do not modify or affect a packet may not be included in the cache. For subsequent packets of the packet flow, the virtual network device processes the subsequent packet using the data indicating the modifications and outcome stored to the cache for the included stages. In this way, the virtual network device may reduce the number of operations applied to subsequent packets of the packet flow. In addition, stage-based learning of operations actually performed, as described in this disclosure, allows the learning to be generic and adaptive. It is usable in any software-driven packet forwarding pipeline in which the internal packet processing path of a virtual network device can be divided into logical stages. These stages can be changed as the packet processing path changes. The learning model can therefore expand and shrink with the software-driven packet forwarding pipeline, making it more generic and flexible as compared to other optimization models.

The techniques of this disclosure may provide one or more technical advantages that realize at least one practical application. For example, the techniques may reduce the number of operations needed to process a given packet and thereby improve the packet processing of a virtual network device. Reducing the number of operations may reduce the number of CPU cycles needed to process each packet, reduce a memory footprint, and may increase the throughput of the virtual network device because the CPU cycles saved on one packet flow can be used to process another packet flow. As another example, the use of user selection and/or automated selection of flows for optimization may facilitate targeted flow optimization.

In an example, computing device includes memory; processing circuitry in communication with the memory; and a virtual network device executed by the processing circuitry and configured to: based on a determination that a second packet received by the virtual network device is associated with a packet flow, apply one or more packet operations for the packet flow to the second packet, wherein the one or more packet operations for the packet flow are stored to an operations database and determined by the virtual network device for the packet flow based on a prior application, by the virtual network device, of one or more packet processing stages to a first packet of the packet flow.

In another example, a method includes based on a determination that a second packet received by the virtual network device is associated with a packet flow, apply, by a virtual network device, one or more packet operations for the packet flow to the second packet, wherein the one or more packet operations for the packet flow are stored to an operations database and determined by the virtual network device for the packet flow based on a prior application, by the virtual network device, of one or more packet processing stages to a first packet of the packet flow.

In yet another example, non-transitory computer-readable media includes instructions that, when executed by processing circuitry of a computing device, causes the computing device to based on a determination that a second packet received by the virtual network device is associated with a packet flow, apply one or more packet operations for the packet flow to the second packet, wherein the one or more packet operations for the packet flow are stored to an operations database and determined by the virtual network device for the packet flow based on a prior application, by a virtual network device, of one or more packet processing stages to a first packet of the packet flow.

The details of one or more examples of this disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements packet processing, in accordance with one or more aspects of this disclosure.

FIG. 2 is a block diagram of an example packet processing module that applies packet operations from an operations database, in accordance with one or more aspects of this disclosure.

FIG. 3 is a block diagram of an example computing device that implements packet processing, in accordance with one or more aspects of this disclosure.

FIG. 4 is a block diagram of an example packet processed by a computing device, in accordance with one or more aspects of this disclosure.

FIG. 5 is a flowchart illustrating example operations for packet processing, in accordance with one or more aspects of this disclosure.

FIG. 6 is a flowchart illustrating an example operation for applying packet operations, in accordance with one or more aspects of this disclosure.

Like reference characters denote like elements throughout the description and figures.

### DETAILED DESCRIPTION

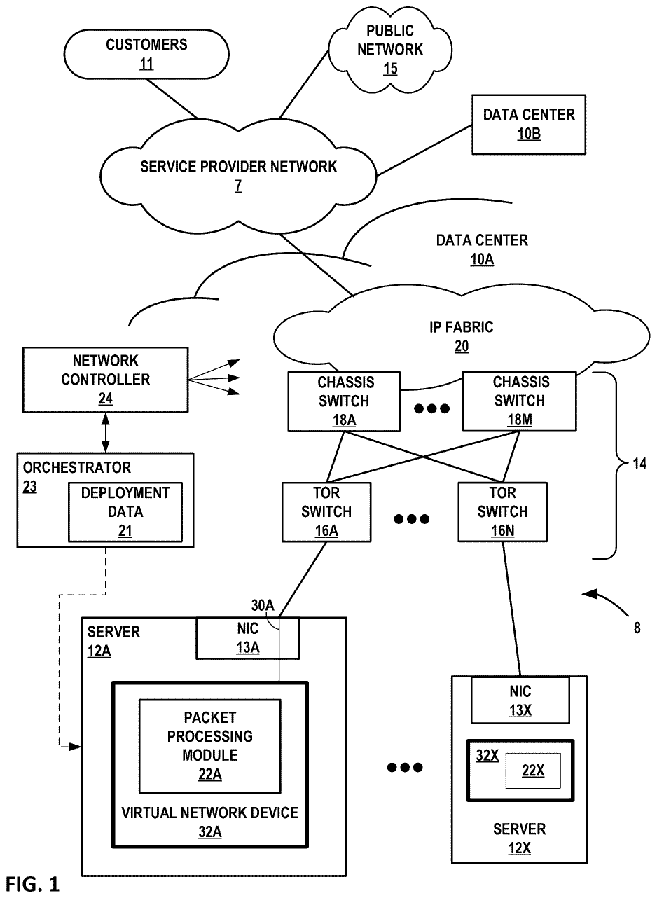

FIG. 1 is a block diagram illustrating an example system that implements packet processing, in accordance with one or more aspects of this disclosure. The system includes virtualized computing infrastructure 8. In general, data center 10A provides an operating environment for applications and services for customer sites 11 (illustrated as “customers 11”) having one or more customer networks coupled to the data center by service provider network 7. Each of data centers 10A-10B (collectively, “data centers 10”) may, for example, host infrastructure equipment, such as networking and storage systems, redundant power supplies, and environmental controls. The techniques are described further primarily with respect to data center 10A illustrated in greater detail.

Service provider network 7 is coupled to public network 15, which may represent one or more networks administered by other providers, and may thus form part of a large-scale public network infrastructure, e.g., the Internet. Public network 15 may represent, for instance, a local area network (LAN), a wide area network (WAN), the Internet, a virtual LAN (VLAN), an enterprise LAN, a layer 3 virtual private network (VPN), an Internet Protocol (IP) intranet operated by the service provider that operates service provider network 7, an enterprise IP network, or some combination thereof.

Although customer sites 11 and public network 15 are illustrated and described primarily as edge networks of service provider network 7, in some examples, one or more of customer sites 11 and public network 15 may be tenant networks within data center 10 or another data center. For example, data center 10A may host multiple tenants (customers) each associated with one or more virtual private networks (VPNs), each of which may implement one of customer sites 11.

Service provider network 7 offers packet-based connectivity to attached customer sites 11, data centers 10, and public network 15. Service provider network 7 may represent a network that is owned and operated by a service provider to interconnect a plurality of networks. Service provider network 7 may implement Multi-Protocol Label Switching (MPLS) forwarding and in such instances may be referred to as an MPLS network or MPLS backbone. In some instances, service provider network 7 represents a plurality of interconnected autonomous systems, such as the Internet, that offers services from one or more service providers. Service provider network 7 may be a layer 3 network and may represent or be part of a core network.

In some examples, data center 10A may represent one of many geographically distributed network data centers. As illustrated in the example of FIG. 1, data center 10A may be a facility that provides network services for customers. A customer of the service provider may be a collective entity such as enterprises and governments or individuals. For example, a network data center may host web services for several enterprises and end users. Other exemplary services may include data storage, virtual private networks, traffic engineering, file service, data mining, scientific- or super-computing, and so on. Although illustrated as a separate edge network of service provider network 7, elements of data center 10A such as one or more physical network functions (PNFs) or virtualized network functions (VNFs) may be included within the service provider network 7 core.

In this example, data center 10A includes storage and/or compute servers (or “nodes”) interconnected via switch fabric 14 provided by one or more tiers of physical network switches and routers, with servers 12A-12X (collectively, “servers 12”) depicted as coupled to top-of-rack switches 16A-16N. Servers 12 are computing devices and may also be referred to herein as “hosts,” “host devices,” “host computing devices,” “compute nodes,” or other similar term. Although only server 12A coupled to TOR switch 16A is shown in detail in FIG. 1, data center 10A may include many additional servers coupled to other TOR switches 16 of the data center 10A, with such servers having hardware and software components similar to those illustrated with respect to server 12A.

Switch fabric 14 in the illustrated example includes interconnected top-of-rack (TOR) (or other “leaf”) switches 16A-16N (collectively, “TOR switches 16”) coupled to a distribution layer of chassis (or “spine” or “core”) switches 18A-18M (collectively, “chassis switches 18”). Although not shown, data center 10A may also include, for example, one or more non-edge switches, routers, hubs, gateways, security devices such as firewalls, intrusion detection, and/or intrusion prevention devices, servers, computer terminals, laptops, printers, databases, wireless mobile devices such as cellular phones or personal digital assistants, wireless access points, bridges, cable modems, application accelerators, or other network devices. Data center 10A may also include one or more physical network functions (PNFs) such as physical firewalls, load balancers, routers, route reflectors, broadband network gateways (BNGs), mobile core network elements, and other PNFs.

In this example, TOR switches 16 and chassis switches 18 provide servers 12 with redundant (multi-homed) connectivity to IP fabric 20 and service provider network 7. Chassis switches 18 aggregate traffic flows and provides connectivity between TOR switches 16. TOR switches 16 may be network devices that provide layer 2 (MAC) and/or layer 3 (e.g., IP) routing and/or switching functionality. TOR switches 16 and chassis switches 18 may each include one or more processors and a memory and can execute one or more software processes. Chassis switches 18 are coupled to IP fabric 20, which may perform layer 3 routing to route network traffic between data center 10A and customer sites 11 by service provider network 7. The switching architecture of data center 10A is merely an example. Other switching architectures may have more or fewer switching layers, for instance. IP fabric 20 may be or include one or more gateway routers.

The term “packet flow,” “traffic flow,” or simply “flow” refers to a set of packets originating from a particular source device or endpoint and sent to a particular destination device or endpoint. A single flow of packets may be identified by a label/tag or tuple, such as the 5-tuple: <source network address, destination network address, source port, destination port, protocol>, for example. This 5-tuple generally identifies a packet flow to which a received packet corresponds. An n-tuple refers to any n items drawn from the 5-tuple. For example, a 2-tuple for a packet may refer to the combination of <source network address, destination network address> or <source network address, source port> for the packet.

Servers 12 may each represent a compute server. For example, each of servers 12 may represent a computing device, such as an x86 processor-based server, configured to operate according to techniques described herein. Servers 12 may provide Network Function Virtualization Infrastructure (NFVI) for an NFV architecture that is an example of a virtualized computing infrastructure.

Any server of servers 12 may be configured with virtual execution elements by virtualizing resources of the server to provide an isolation among one or more processes (applications) executing on the server. “Hypervisor-based” or “hardware-level” or “platform” virtualization refers to the creation of virtual machines that each includes a guest operating system for executing one or more processes. In general, a virtual machine provides a virtualized/guest operating system for executing applications in an isolated virtual environment. Because a virtual machine is virtualized from physical hardware of the host server, executing applications are isolated from both the hardware of the host and other virtual machines. Each virtual machine may be configured with one or more virtual network interfaces (VNIs) for communicating on corresponding virtual networks.

Virtual networks are logical constructs implemented on top of the physical networks. Virtual networks may be used to replace VLAN-based isolation and provide multi-tenancy in a virtualized data center, e.g., data center 10A. Each tenant or an application can have one or more virtual networks. Each virtual network may be isolated from all the other virtual networks unless explicitly allowed by security policy.

Virtual networks can be connected to and extended across physical Multi-Protocol Label Switching (MPLS) Layer 3 Virtual Private Networks (L3VPNs) and Ethernet Virtual Private Networks (EVPNs) networks using a datacenter 10 gateway router (not shown in FIG. 1). Virtual networks may also be used to implement Network Function Virtualization (NFV) and service chaining.

Virtual networks can be implemented using a variety of mechanisms. For example, each virtual network could be implemented as a Virtual Local Area Network (VLAN), Virtual Private Networks (VPN), etc. A virtual network can also be implemented using two networks—the physical underlay network made up of IP fabric 20 and switching fabric 14 and a virtual overlay network. The role of the physical underlay network is to provide an “IP fabric,” which provides unicast IP connectivity from any physical device (server, storage device, router, or switch) to any other physical device. The underlay network may provide uniform low-latency, non-blocking, high-bandwidth connectivity from any point in the network to any other point in the network.

One or more of servers 12 may each include a corresponding one of virtual network devices 32A-32X (collectively, “virtual network devices 32”), which will be described with respect to virtual network device 32A. Virtual network device 32A is a software-based implementation of a physical network function, such as a router, switch, firewall, load balancer, or NAT gateway, and includes packet processing module 22A to perform packet processing in accordance with its network function (again, virtualized from a physical network function).

Virtual network device 32A executes on server 12A. Server 12A can execute multiple different virtual network devices. Virtual network device 32 may operate within a hypervisor, container, or virtual machine hosted on server 12A and may use SR-IOV, DPDK, or XDP to enable high-speed packet processing. By decoupling network functions from physical appliances, virtual network device 32 provide flexibility, scalability, and rapid deployment in environments such as Network Functions Virtualization (NFV) environments, public or private clouds, and data centers generally. Data center 10A is an example of these environments.

Virtual network device 32A, depending on its network function, may perform packet forwarding, firewall rule enforcement, traffic shaping, deep packet inspection, and tunneling protocols such as IPsec or VXLAN. Orchestrator 23 may automatically instantiate, scale, and update virtual network devices 32 as part of service chaining or intent-based networking frameworks.

In some examples, one or more of virtual network devices 32 is a virtual router. In some examples, one or more of virtual network devices 32 may be a containerized network router (CNR—also referred to as a “containerized router”). As such, virtual network device 32A may include containerized virtual router that implements a data plane for the containerized router, as well as a containerized routing protocol process that implements a control plane for the containerized router. Because the data plane is to perform high-speed packet processing, packet processing module 22A may represent or include the containerized virtual router. Further details regarding CNRs may be found in U.S. Pat. No. 12,160,811, the entirety of which is incorporated herein by reference.

Virtual network devices 32, when implementing virtual routers, may create a virtual overlay network on top of the physical underlay network using a mesh of dynamic “tunnels” amongst themselves. These overlay tunnels can be MPLS over GRE/UDP tunnels, or VXLAN tunnels, or NVGRE tunnels, for instance. The underlay physical routers and switches may not store any per-tenant state for virtual machines or other virtual execution elements, such as any Media Access Control (MAC) addresses, IP address, or policies. The forwarding tables of the underlay physical routers and switches may, for example, only contain the IP prefixes or MAC addresses of the physical servers 12. (Gateway routers or switches that connect a virtual network to a physical network are an exception and may contain tenant MAC or IP addresses.)

Servers 12 may host workloads that are virtual network endpoints for one or more virtual networks that operate over the physical network represented here by IP fabric 20 and switch fabric 14. Although described primarily with respect to a data center-based switching network, other physical networks, such as service provider network 7, may underlie the one or more virtual networks.

Each of servers 12 may host one or more workloads each having at least one virtual network endpoint for one or more virtual networks configured in the physical network. A virtual network endpoint for a virtual network may represent one or more workloads that share a virtual network interface for the virtual network. For example, a virtual network endpoint may be a virtual machine, a set of one or more containers (e.g., a pod), or another other workload(s), such as a layer 3 endpoint for a virtual network. The term “workload” encompasses virtual machines, containers, and other virtualized computing resources that provide an at least partially independent execution environment for applications. The term “workload” may also encompass a pod of one or more containers. Server 12A may host multiple virtual network endpoints in the form of pods each having one or more containers. However, a server 12 may execute as many workloads as is practical given hardware resource limitations of the server 12. Each of the virtual network endpoints may use one or more virtual network interfaces to perform packet I/O or otherwise process a packet. For example, a virtual network endpoint may use one virtual hardware component (e.g., an SR-IOV virtual function) enabled by NIC 13A to perform packet I/O and receive/send packets on one or more communication links with TOR switch 16A. Other examples of virtual network interfaces are described below.

Servers 12 include respective network interface cards (NICs) 13A-13X (collectively, “NICs 13”), which each includes at least one interface to exchange packets with TOR switches 16 over a communication link. For example, server 12A includes NIC 13A illustrated as having two links to TOR switch 16A. Any of NICs 13 may provide one or more virtual hardware components for virtualized input/output (I/O). A virtual hardware component for I/O may be a virtualization of the physical NIC (the “physical function”). For example, in Single Root I/O Virtualization (SR-IOV), which is described in the Peripheral Component Interface Special Interest Group SR-IOV specification, the PCIe Physical Function of the network interface card (or “network adapter”) is virtualized to present one or more virtual network interfaces as “virtual functions” for use by respective endpoints executing on the server 12. In this way, the virtual network endpoints may share the same PCIe physical hardware resources and the virtual functions are examples of virtual hardware components. As another example, one or more servers 12 may implement Virtio, a para-virtualization framework available, e.g., for the Linux Operating System, that provides emulated NIC functionality as a type of virtual hardware component to provide virtual network interfaces to virtual network endpoints. As another example, one or more servers 12 may implement Open vSwitch to perform distributed virtual multilayer switching between one or more virtual NICs (vNICs) for hosted virtual machines, where such vNICs may also represent a type of virtual hardware component that provide virtual network interfaces to virtual network endpoints. In some instances, the virtual hardware components are virtual I/O (e.g., NIC) components. In some instances, the virtual hardware components are SR-IOV virtual functions. In some examples, any server of servers 12 may implement a Linux bridge that emulates a hardware bridge and forwards packets among virtual network interfaces of the server or between a virtual network interface of the server and a physical network interface of the server. For Docker implementations of containers hosted by a server, a Linux bridge or other operating system bridge, executing on the server, that switches packets among containers may be referred to as a “Docker bridge.” The term “virtual router” as used herein may encompass a Contrail or Tungsten Fabric virtual router, Open vSwitch (OVS), an OVS bridge, a Linux bridge, Docker bridge, or other device and/or software that is located on a host device and performs switching, bridging, or routing packets among virtual network endpoints of one or more virtual networks, where the virtual network endpoints are hosted by one or more of servers 12. Virtual network device 32A is an example of such a virtual router.

Where operating as virtual routers, each of virtual network devices 32 may implement one or more routing instances for corresponding virtual networks within data center 10A to provide virtual network interfaces and route packets among the virtual network endpoints/workloads also executing on servers 12 (workloads not shown for ease of illustration). Each of the routing instances may be associated with a network forwarding table. Each of the routing instances may include a virtual routing and forwarding instance (VRF) for an Internet Protocol-Virtual Private Network (IP-VPN). Packets received by the virtual network device 32A of server 12A, for instance, from the underlying physical network fabric of data center 10A (i.e., IP fabric 20 and switch fabric 14) may include an outer header to allow the physical network fabric to tunnel the payload or “inner packet” to a physical network address for a network interface card 13A of server 12A that executes the virtual network device. The outer header may include not only the physical network address of the network interface card 13A of the server but also a virtual network identifier such as a VxLAN tag or Multiprotocol Label Switching (MPLS) label that identifies one of the virtual networks as well as the corresponding routing instance executed by the virtual network device 32A. An inner packet includes an inner header having a destination network address that conforms to the virtual network addressing space for the virtual network identified by the virtual network identifier.

In such examples, virtual network devices 32 terminate virtual network overlay tunnels and determine virtual networks for received packets based on tunnel encapsulation headers for the packets, and forwards packets to the appropriate destination virtual network endpoints for the packets. For server 12A, for example, for each of the packets outbound from virtual network endpoints hosted by server 12A, the virtual network device 32A attaches a tunnel encapsulation header indicating the virtual network for the packet to generate an encapsulated or “tunnel” packet, and virtual network device 32A outputs the encapsulated packet via overlay tunnels for the virtual networks to a physical destination computing device, such as another one of servers 12. Any of virtual network devices 32 may execute the operations of a tunnel endpoint to encapsulate inner packets sourced by virtual network endpoints/workloads to generate tunnel packets and decapsulate tunnel packets to obtain inner packets for routing to other virtual network endpoints/workloads.

In some examples, each of virtual network devices 32 may represent a SmartNIC-based virtual router, kernel-based virtual router (i.e., executed as a kernel module), or a Data Plane Development Kit (DPDK)-enabled virtual router in various examples. A DPDK-enabled virtual network device 32A may use DPDK as a data plane. In this mode, virtual network device 32A runs as a user space application that is linked to the DPDK library (not shown). This is a performance version of a virtual router and is commonly used by telecommunications companies, where the VNFs are often DPDK-based applications. The performance of virtual network device 32A as a DPDK virtual router can achieve ten times higher throughput than a virtual router operating as a kernel-based virtual router. The physical interface is used by DPDK's poll mode drivers (PMDs) instead of Linux kernel's interrupt-based drivers.

A user-I/O (UIO) kernel module, such as vfio or uio_pci_generic, may be used to expose a physical network interface's registers into user space so that they are accessible by the DPDK PMD. When NIC 13A is bound to a UIO driver, it is moved from Linux kernel space to user space and therefore no longer managed nor visible by the Linux OS. Consequently, it is the DPDK application (i.e., virtual network device 32A in this example) that fully manages the NIC 13. This includes packets polling, packets processing, and packets forwarding. User packet processing steps may be performed by the virtual network device 32A DPDK data plane with limited or no participation by the kernel (kernel not shown in FIG. 1). The nature of this “polling mode” makes the virtual network device 32A DPDK data plane packet processing/forwarding much more efficient as compared to the interrupt mode, particularly when the packet rate is high. There are limited or no interrupts and context switching during packet I/O.

Additional details of an example of a DPDK vRouter are found in “DAY ONE: CONTRAIL DPDK vROUTER,” 2021, Kiran K N et al., Juniper Networks, Inc., which is incorporated by reference herein in its entirety.

Virtual network device 32A may include a containerized routing protocol daemon. A containerized routing protocol daemon (cRPD) is a routing protocol process that is packaged as a container and may run in Linux-based environments, cRPD may be executed in the user space of the host as a containerized process. Thus, cRPD makes available the rich routing software pedigree of physical routers on Linux-based compute nodes, e.g., servers 12 in some cases. cRPD provides control plane functionality. This control plane is thus containerized. For example, a cRPD may implement the control plane for a virtualized network device 32A in conjunction with a software-driven packet processing pipeline implemented by packet processing module 22A, also executed by server 12A, that implements the virtual router data plane. The cRPD and virtual router data plane may together implement a virtual router, such as a containerized network router as described above.

Virtualized computing infrastructure 8 implements an automation platform for automating deployment, scaling, and operations of virtual execution elements across servers 12 to provide virtualized infrastructure for executing application workloads and services. In some examples, the platform may be a container orchestration platform that provides a container-centric infrastructure for automating deployment, scaling, and operations of containers to provide a container-centric infrastructure. “Orchestration,” in the context of a virtualized computing infrastructure generally refers to provisioning, scheduling, and managing virtual execution elements and/or applications and services executing on such virtual execution elements to the host servers available to the orchestration platform. Container orchestration, specifically, permits container coordination and refers to the deployment, management, scaling, and configuration, e.g., of containers to host servers by a container orchestration platform. Example instances of orchestration platforms include Kubernetes, Docker swarm, Mesos/Marathon, OpenShift, OpenStack, VMware, and Amazon ECS.

Orchestrator 23 represent one or more orchestration components for a container orchestration system. In some examples, virtual network devices 32 are also containerized and orchestrated by orchestrator 23.

Elements of the automation platform of computing infrastructure 8 include at least servers 12 and orchestrator 23, and may include network controller 24. Containers may be deployed to a virtualization environment using a cluster-based framework in which a cluster master node of a cluster manages the deployment and operation of containers to one or more cluster minion nodes of the cluster. The terms “master node” and “minion node” used herein encompass different orchestration platform terms for analogous devices that distinguish between primarily management elements of a cluster and primarily container hosting devices of a cluster. For example, the Kubernetes platform uses the terms “cluster master” and “minion nodes,” while the Docker Swarm platform refers to cluster managers and cluster nodes.

Orchestrator 23 and network controller 24 may execute on separate computing devices or execute on the same computing device. Each of orchestrator 23 and network controller 24 may be a distributed application that executes on one or more computing devices. Orchestrator 23 may implement master nodes for one or more clusters each having one or more minion nodes implemented by respective servers 12 (also referred to as “compute nodes”).

In general, optional network controller 24 may control the network configuration of the data center 10A fabric to, e.g., establish one or more virtual networks for packetized communications among virtual network endpoints. Network controller 24 provides a logically and in some cases physically centralized controller for facilitating operation of one or more virtual networks within data center 10A. In some examples, network controller 24 may operate in response to configuration input received from orchestrator 23 and/or an administrator/operator.

In general, orchestrator 23 controls the deployment, scaling, and operations of containers across clusters of servers 12 and providing computing infrastructure, which may include container-centric computing infrastructure. Orchestrator 23 and, in some cases, network controller 24 may implement respective cluster masters for one or more Kubernetes clusters. As an example, Kubernetes is a container management platform that provides portability across public and private clouds, each of which may provide virtualization infrastructure to the container management platform.

Orchestrator 23 includes deployment data 21, which may be a data structure used by orchestrator 23 to manage the virtualization infrastructure included in computing infrastructure 8. Deployment data 21 may include one or more types of data structures, such as Kubernetes manifests and/or Helm Charts, used to manage the deployment of applications to servers 12 for execution. For example, deployment data 21 may include files that describe the resources of a Kubernetes cluster as well as templates used to deploy virtual network devices 32 to facilitate Kubernetes networking.

Kubernetes networking between pods is via plug-ins called Container Network Interfaces (CNIs) (also known as Container Network Interface plugins). However, the networking capabilities of typical CNIs are rather rudimentary and not suitable when the containerized network functions the CNI serves play a pivotal role within a network. A virtualized router, as described herein, provides a better fit for these situations. A virtualized router is a router with a containerized control plane that allows an x86 or ARM based host to be a first-class member of the network routing system, participating in protocols such as Intermediate System to Intermediate System (IS-IS) and Border Gateway Protocol (BGP) and providing Multiprotocol Label Switching/Segment Routing (MPLS/SR) based transport and multi-tenancy. In other words, rather than the platform being an appendage to the network (like a customer edge (CE) router), it may be operating as a provider edge (PE) router.

Virtual network device 32A may be a cloud-native application and support installation using the Kubernetes manifests or Helm Charts included in deployment data 21. This includes the initial configuration of virtual network device 32A, which may include configuration of the virtual network function applied by virtual network device 32A. Where this is a virtual router, configuration may including configuring routing protocols and one or more virtual private networks. Ongoing configuration changes during the lifetime of virtual network device 32A may be via a choice of CLI, Kubernetes manifests, NetConf or Terraform.

Virtual network devices 32 include respective packet processing modules 22 to perform packet processing operations via stage-based packet processing pipelines, where each pipeline includes a plurality of stages that may be applied to a packet. Packet processing modules 22 may apply one or more types of packet processing operations for the virtual function being implemented, such as modifying a header start adjustment, writing data to a packet header, outputting the packet via an interface, performing a firewall lookup, modifying a packet offset, applying a firewall rule to drop a packet, incrementing a counter, decrementing a counter, and/or other types of packet operations.

Packet processing modules 22 may apply the packet operations via the packet processing stages, where each packet processing stage is configured to apply a type of packet operation. Packet processing modules 22 may sequentially process packets through the packet processing stages for the packet processing pipelines. As part of processing the packets, packet processing modules 22 may direct a packet from a first packet processing stage to the next packet processing stage based on the result of the first stage (e.g., a given packet may be directed to the next stage based on the operation performed in a previous packet processing stage).

The packet processing pipelines implemented by packet processing modules 22 may process packets through stages regardless of whether the stages apply operations to the packets. In other words, packet processing module 22A may process a packet through each stage of a pipeline regardless of whether each stage applies a packet operation. Consequently, packet processing modules 22 may consume compute resources (e.g., CPU cycles) processing packets through packet processing stages that do not apply packet operations to the packets. The use of compute resources for packet processing stages that do not apply packet operations may reduce the availability of the compute resources to process other packets or perform other operations due to the compute resources being consumed for packet processing stages that do not apply any packet operations.

In accordance with the techniques of this disclosure, packet processing modules 22 apply packet operations to packets of a packet flow, the packet operations having been previously determined by the packet processing modules 22 for the packet flow and cached in a database of packet operations. This is described further in detail with respect to example packet processing module 22A. Packet processing module 22A determines packet processing operations associated with a packet flow by observing the processing of a packet associated with the flow through the packet processing stages of its pipeline. As part of determining the packet processing operations, packet processing module 22A determines packet operations to store (or “cache”) in the database of packet operations (alternatively described to as a “cache”) for use in processing other packets associated with the flow.

Orchestrator 23 may push packet flow definitions included in deployment data 21 to packet processing module 22A for use in determining packet flows for packet operations reduction techniques. Orchestrator 23 may enable a user to define a template in the deployment data 21 (e.g., a Helm chart) to indicate the packet fields and values that are to be used to identify a packet flow and push the user-defined deployment data to packet processing module 22A. Orchestrator 23 may pass data from a template included in deployment data 21 to a data path (e.g., packet processing module 22A) as a configuration for use in identifying and selecting packet flows for application of packet operations reduction. Orchestrator 23 may use a Helm chart or other information included in deployment data 21 to tailor the learning of packet processing to a particular application or a particular deployment of network resources, for instance. In some examples, orchestrator 23 receives a user configuration of a flow definition. Orchestrator 23 pushes the flow definition to packet processing module 22A as a configuration for use in identifying and selecting packet flows for application of packet operations reduction.

Packet processing module 22A may determine packet flows for selective application of packet operations reduction techniques by packet processing module 22A. Packet processing module 22A may identify a flow for application of packet operations reduction based on the flow definitions received from orchestrator 24 and/or based on other factors. Packet processing module 22A may identify a defined flow using one or more types of identifiers of the flow, such as a 5-tuple, 6-tuple, protocol type, or a mask associated with the flow, among other types of identifiers.

Packet processing module 22A may determine packet operations for a packet flow that are reduced and/or condensed from the packet operations performed packet processing module 22A. Packet processing module 22A may determine the packet operations for a packet associated with a packet flow based on determining that the associated packet flow is included in a flow definition received from orchestrator 23. Packet processing module 22A may determine the packet operations in one or more ways, such as by removing packet processing stages that do not perform a packet operation, determining packet operations that may be combined with other packet operations, determining packet operations that may be dropped from the packet operations performed by the learning thread, and/or in other ways. In an example, packet processing module 22A determines a condensed packet processing operation that is a combination at least two of the one or more packet processing operations performed by a packet learning thread.

Packet processing module 22A may store the determined packet operations in an operations database or other storage or cache for use in processing subsequent packets. Packet processing module 22A may generate an entry in the operations database and store the determined packet operations as associated with the packet flow in the generated entry. For example, packet processing module 22A may generate an entry in the operations database that includes a list and order of the packet operations and a hash of packet data for packets of the packet flow.

Having determined the packet operations for the packet flows, upon receiving a subsequent packet of the packet flow, packet processing module 22A may determine whether the operations database includes an entry for the packet flow. Packet processing module 22A may determine whether the operations database includes an entry to determine whether reduced packet operations have been learned for the packet flow and may be applied to the received packet. Based on determining that the operations database includes an entry for the packet flow associated with the received packet, packet processing module 22A may perform the packet operations included in the entry. For example, packet processing module 22A may retrieve the packet operations included in the entry for application by compute resources of server 12A.

The techniques of this disclosure may provide one or more practical advantages that realize at least one technical advantage. For example, the use of reduced packet operations may enable virtual network device 32A to process packets with comparatively fewer compute resources than are required to fully execute the packet processing pipeline including all packet processing stages. As such, the reduction in compute resources required to process packets may enable the network device to more quickly process packets and/or process a comparatively greater number of packets with the same amount of compute resources, thereby increasing the throughput of virtual network device 32A. In another example, the use of a learning thread may enable packet processing modules to automatically determine packet operations from which to determine reduced packet operations without requiring human configuration of the packet operations.

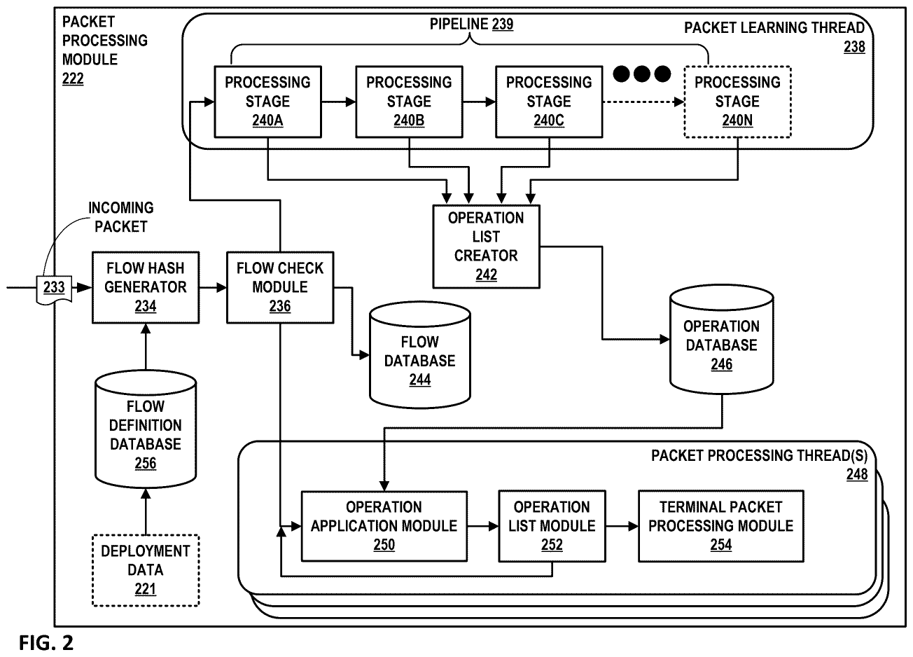

FIG. 2 is a block diagram of an example packet processing module 222 that applies packet operations from an operations database, in accordance with one or more aspects of this disclosure. Packet processing module 222 may be an instance of one of packet processing modules 22 as illustrated in FIG. 1 and provide similar functionality.

Packet processing module 222 may obtain deployment data 221 that includes flow definitions from orchestrator 23 as illustrated in FIG. 1. While illustrated as included within packet processing module 222, orchestrator 23 may push only a portion of deployment data 221 to packet processing module 222 to configure flow definitions for packet procession module 222. Packet processing module 222 may receive flow definitions included in deployment data 231 for use in configuring flow definition database 256 for identifying packet flows for application of reduction of packet operations. For example, packet processing module 222 may receive one or more flow definitions, such as those listed below, for use in packet selection:
SMAC|DMAC|IP|TCP
SMAC|DMAC|IP (dst=10.0.0.0/16)|UDP (dport=9000)
SMAC(smac=11:22:33:44:55:66)|DMAC|IP6|TCP
SMAC|DMAC|MPLS|IP|UDP

Packet processing module 222 accesses flow definition database 256, which may be a data structure configured to store flow definitions of packet flows. A packet flow definition specifies the matching criteria for network traffic based on packet attributes such as source/destination IP, port numbers, protocol, and/or interface. For instance, packet processing module 222 may store flow definitions included in deployment data 221 to flow definition database 256 for use in selecting flows. For example, packet processing module 222 may store flow definitions of packet flows configured between pods of a Kubernetes deployment for use in selecting flows for learning and processing by packet processing threads. While illustrated within packet processing module 222, flow definition 256 may be a software component of a virtual network device executing packet processing module 222.

Packet processing module 222 accesses flow database 244, which may be a data structure configured to store packet flow identifiers, e.g., hash values, that have been learned by packet processing module 222. Flow database 244 may be a datastore, database, data repository, table, list, and/or other type of data structure. Packet processing module 222 may store information regarding packet flows and whether the packet flows have been “learned” by packet processing threads. For example, packet processing module 222 may store information regarding whether a given packet flow should be processed by a learning thread or processed using cached packet operations. Packet processing module 222 may store information regarding the learned packet flows in one or more ways, such as an entry in a table that includes an indication of a packet flow, an indication of whether the packet flow has been learned, and/or other information.

Packet processing module 222 may receive a packet 233 (e.g., “INCOMING PACKET” as illustrated in FIG. 2) and process packet 233 using flow hash generator 234. Flow hash generator 234 may be a software component of packet processing module 222 configured to generate hashes of packets for use in identifying incoming packets as associated with a packet flow. For example, flow hash generator 234 may generate a hash of packet 233, the hash value identifying incoming packet as associated with a particular packet flow. The hash value therefore identifies the packet flow. In some examples, flow hash generator 234 may use flow definitions that are programmable. Placement of a network node may drive what field should be part of the flow. Flow hash generator 234 may use an L2 header (Ethernet), L3 header (MPLS, IPv4 or IPV6), L4 header (UDP/TCP/ . . . ) and any other field that would uniquely identify packets of a packet flow.

Packet processing module 222 determines whether packet 233 is associated with a packet flow that has been selected. Packet processing module 222 may compare information regarding the packet flow associated with packet 233 to information in flow definition database 256 to determine whether packet 233 is associated with a packet flow defined in flow definition database 256. In an example, packet processing module 222 receives packet 233. Flow hash generator 234 computes a hash of packet data of the packet and compares the hash value to packet flow definitions included in flow definition database 256 and, upon identifying a match, determines that the packet flow has been selected for reduction of packet operations. Flow definition database 256 may store a hash value of packet data derived from flow definitions for use in comparing to hash values computed for received packets. Example hash algorithms include SHA-1, MD5, SHA-256, et al.

Packet processing module 222 includes flow check module 236, which may be a software component configured to determine whether packet 233 is associated with a packet flow that has been learned by packet processing module 222. Flow check module 236 may determine whether packet 233 is associated with a learned flow in response to packet processing module 222 determining that the flow associated with packet 233 has been selected for reduction of packet operations. Flow check module 236 may determine, based on a hash value of packet data of packet 233, whether the packet flow has been learned by packet processing module 222. As part of determining whether the packet flow of packet 233 has been learned, flow check module 236 may compare the hash value of packet 233 to entries in flow database 244. (Flow database 244 may store a hash value of packet data for packets of learned packet flows.) In some examples, flow check module 236 may determine whether the packet flow has been learned by packet processing module 222 (e.g., whether flow database 244 includes an identifier (e.g., a hash value) of the packet flow associated with the received packet) and should be processed by packet processing thread(s) 248 rather than packet learning thread 238.

Flow check module 236 may determine how packet processing module 222 is to process incoming packets. Flow check module 236 may compare an identifier of a packet flow (e.g., a hash value) associated with a packet to packet flow identifiers stored in flow database 244 to determine which packet processing thread should process a packet. In an example, flow check module 236 compares a hash value for a received packet to packet flow identifiers stored in flow database 244 and, based on matching the hash value to a packet flow identifier stored in flow database 244, determines that packet flow associated with the received packet has been learned and that the received packet should be routed to a packet processing thread 248 that implements a reduced set of packet instructions for the associated packet flow. In some examples, flow check module 236 may determine from flow definition database 256 that a packet flow has been selected for reduced packet operations but determine from flow database 244 that packet processing module 222 has not yet learned the packet processing operations associated with the packet flow and route an incoming packet to packet learning thread 238.

Packet processing module 222 includes packet learning thread 238, which may be an execution thread configured to process packets. Packet learning thread 238 implements software-driven packet processing pipeline 239 (“pipeline 239”) with one or more processing stages 240A-240N (collectively, “packet processing stages 240”) that each implements one or more packet operations. Packet processing module 222 may process packet 233 associated with a selected flow using packet learning thread 238, where packet learning thread 238 is a packet processing thread configured to execute the software-driven packet processing pipeline 239 including the full number of packet processing stages 240. Packet learning thread 239 may process packets using processing stages 240 of pipeline 239 in a sequential order (e.g., processing stage 240A, then processing stage 240B, and so on). In an example, processing stage 240A modifies the header of a received packet, processing stage 240B increments a counter, and processing stage 240C directs the packet to an interface for output. In some examples, each of packet processing stages 240 results in one operation, e.g., a packet modification, a packet operation, or a system operation. In some cases, a packet processing stage 240 may be a no operations or “no-op”, i.e., no action taken. Although multiple instructions may be executed as part of any one of stages 240, the operation of any of packet processing stages 240 may be simplified as an “operation,” as described in further detail below.

In computing, a thread is a unit of execution within a process, capable of running independently while sharing the same memory space as other threads in the same process. Multiple threads can run concurrently within a single process, enabling parallelism and efficient use of CPU resources. Threads share code, data, and system resources, but each thread has its own stack, program counter, and registers to maintain execution state.

Each of processing stages 240 includes one or more instructions. Packet learning thread 238 processes a packet using the instructions of the processing stages 240, i.e., pipeline 239 is driven by instruction-level execution, involving memory accesses, conditionals, and lookups over in-memory data structures (not shown). Upon arrival at a network interface card (NIC), packet 233 is typically placed in a memory buffer (e.g., via DMA) and the CPU is notified through an interrupt or polled using a high-performance framework like DPDK or XDP. Packet learning thread 238 may parse packet 233 by loading header bytes into CPU registers using instructions and to extract fields, such as source/destination IP, ports, protocol, etc. These extracted values may serve as keys for lookup operations in software-managed data structures such as hash tables, radix trees, or trie structures, each of which involves one or more CPU instructions (e.g., pointer resolving, conditional branches) to traverse and retrieve results. For example, a longest prefix match operation may involve traversing a radix tree data structure, while an access control list (ACL) rule may be matched via sequential evaluation or binary search. Continuing this example, once a match is found, the CPU executes action instructions to modify packet 233 or its metadata, such as rewriting headers, updating counters in memory, or enqueueing the packet to an output interface buffer. Decisions about QoS, forwarding, or filtering are often implemented using control flow logic and may trigger further lookups (e.g., NAT table, connection tracking). After processing, unless packet 233 is dropped, the packet is transmitted by copying it into an output buffer, from which the NIC reads the packet data and outputs the packet on an output interface.

In this way, like a physical networking device, virtual network devices 32 implements an internal packet path made up of data structures and instructions, here organized as processing stages 240 of pipeline 239, executed by threads. Packet processing module 222 may apply this packet path to process the packet in a pipeline fashion (e.g., pipeline 239). A packet processed by pipeline 239 will hit each stage in the pipeline whether or not the packet is required to be processed in that stage. Furthermore, each stage or processing stages 240 may consider multiple conditions that would alter the path of packet 233. For example, processing stage 240A may subject a packet to multiple conditions before choosing the path.

In a networking topology, each node (e.g., any of virtual network devices 32) may operate with a specific purpose. Given a packet construct (the contents of the packet), a packet may take a path that is fixed until a network event changes the path. A cloud native networking device like the virtual networking device executing packet processing module 222 may run on different environments such as on-prem, public cloud, and private cloud. The execution of packet processing module 222 may pose a question on predicable performance and how to standardize performance given the possibilities at which it can run.

Two main aspects of a system may influence the performance of packet path. These include the number of instructions that can be executed per CPU cycle and the number of instructions required to process a packet. In many scenarios, the number of instructions per CPU cycle is fixed given the type of CPU. However, packet processing module 222 may, in accordance with techniques of this disclosure, reduce the number of instructions needed to process a given packet.

Packet processing module 222 accesses operation database 246, which may be a data structure configured to store packet operations. Packet processing module 222 may store packet operations in operation database 246 as associated with packet flow identifiers. For example, packet processing module 222 may store packet operations observed by operation list creator 242 in operation data 246. While illustrated within packet processing module 222, operation database 246 may be included in a virtual network device that provides packet processing module 222.

Packet processing module 222 includes operation list creator 242, which may be a software component of packet processing module 222 configured to determine and cache packet operations performed by packet learning thread 238 using pipeline 239. Operation list creator 242 may determine packet operations applied by processing stages 240 of pipeline 239 to a packet and store, to operation database 246, the operations applied to the packet along with a packet flow identifier for the packet flow associated with the packet.

Operation list creator 242 may determine packet operations used to process packet 233 in one or more formats. For example, operation list creator 242 may determine packet operations in accordance with the format as shown in Table I below:

TABLE I

| | | |
|---|---|---|
| Sequence | Type of Operation | Data |
| number | 0 = packet modification | <Packet modification/Packet |
| | 1 = packet operation | operation/System operation> |
| | 2 = system operation | definition given below. |

Operation list creator 242 may determine packet operations that include a sequence number of the packet operation, an indication of the type of packet operation (e.g., packet modification indicated with a “0”), and information regarding the packet operation. An example of a packet operation to perform packet modifications is illustrated in Table II below:

TABLE II

| | | | | | | |
|---|---|---|---|---|---|---|
| Sequence | 0 | 0 (data | Offset | Action | Number | What to |
| number | | action) | from | 0 = shrink | of | write (in |
| | | | packet | 1 = expand | bytes | case of |
| | | | start | 2 = write | | write |
| | | | | 3 = increment | | action) |
| | | | | 4 = decrement | | |

Operation list creator 242 may determine a packet modification operation in accordance with the format illustrated in Table II above. For example, operation list creator 242 may determine a packet operation that includes an offset from the start of the packet, an indication of the type of packet operation (e.g., “1” corresponding to expanding a section of the packet, the number of bytes associated with the packet operation, and what information to write to the packet).

Operation list creator 242 may determine a packet operation in accordance with the format illustrated in Table III below. For instance, operation list creator 242 may create an entry for a packet operation that includes an indication of whether the packet is to be accepted, dropped, or mirrored as well as an indication of an ongoing interface when the packet is to be accepted or mirrored.

TABLE III

| | | | |
|---|---|---|---|
| Sequence | 1 | Packet operation | Operation Data |
| number | | 0 = Accept | Outgoing interface |
| | | 1 = drop | in case of Accept and |
| | | 2 = Mirror | Mirror |

Operation list creator 242 may determine a system operation in accordance with the format illustrated in Table IV below, where the system operation is a type of packet operation. Operation list creator 242 may determine a system operation that includes the type of system operation (e.g., modifying a counter), an address of the counter, whether to increment or set a counter, the number of bytes to write to the packet, and a value to write to the counter should the counter be set to a value.

TABLE IV

| | | | | | | |
|---|---|---|---|---|---|---|
| Sequence | 2 | Type of | Address | Operation | Number of | Value |
| number | | Operation | | 0 = | bytes to | (used in |
| | | 0 = | | increment | write | case of |
| | | Counter | | 1 = set | | set) |

Operation list creator 242 may determine packet operations for a packet path through pipeline 239. For instance, operation list creator 242 may determine a data path that is divided into multiple predefined stages with not all stages activated for a given packet. For instance, pipeline 239 may provide processing stages 240, where not all of the stages are applicable to all types of packets. In some examples, operation list creator 242 captures, from each of processing stages 240, packet and system operation that occurred at that stage. Operation list creator 242 may determine packet encapsulation operations by:
Observing packet header start adjustment (packet modification);
Observing data written to packet header (packet modification);
Observing outgoing interface (packet operation);
Observing Class of Service marking; and/or
Observing packet offset modified (packet modification).

In some examples, operation list creator 242 may determine packet operations related to a firewall by:
Observing the result of a firewall lookup (packet operation) and/or
Observing counter increments (system operation).

Operation list creator 242 may determine packet operations based on a prior application, by packet learning thread 238, of processing stages 240 to a first packet used to process packet 233, e.g., an initial packet of the packet flow. In an example, packet processing module 222 receives a first packet prior to receiving a second packet and processes the first packet using processing stages 240. Operation list creator 242 observes the packet operations applied by processing stages 240 and stores the packet operations to operation database 246.

In some examples, packet processing module 222 may determine packet operations for multiple packet flows. In an example, packet processing module 222 determines packet operations for a first packet flow to apply to a second packet using a first packet. Packet processing module 222, based on a determination that a fourth packet received by the packet processing module 222 subsequent to a third packet is associated with a second packet flow, applies one or more second packet operations for the second packet flow to the fourth packet, wherein the one or more second packet operations for the second packet flow are stored to operation database 246 and determined by packet processing module 222 for the second packet flow based on a prior application, by packet processing module 222, of one or more second packet processing stages to a third packet of the second packet flow.

In some examples, operation list creator 242 may then process observed or determined packet operations through an optimization or reduction process. For instance, operation list creator 242 may remove packet operations that do not modify packet 233 or otherwise affect packet processing, such as counting. Likewise, operation list creator 242 may remove packet outcomes other than, e.g., forward and drop, as such packet operations may not contribute to the packet processing for a given flow. Operation list creator 242 may generate a list specifying packet operations to be performed on packet 233 and an ordering for the packet operations. Operation list creator 242 stores the packet operations to operation database 246. Operation list creator 242 may use each of stage 240 in packet pipeline 239 to capture two pieces of information: modifications done to the packet and the outcome of the packet (e.g., marked for forward or drop). Operation list creator 242 may determine the information as metadata of the associated stage of processing stages 240. Operation list creator 242 may perform the determination of packet operation for each of stages 240 for a given packet, create a list of metadata, and sort the metadata by the stage number.

For example, operation list creator 242 may observe stage 240A modifying the header of a received packet, processing stage 240B incrementing a counter, and processing stage 240C directing the packet to an interface for output when packet learning thread 238 is processing packet 233. Operation list creator 242 may create a simplified operation for stage 240A relative to the instructions executed by stage 240A. Because the header is modified, operation list creator 242 may specify a simplified operation as, e.g., “write header field X with data N”. Thus, multiple instructions of stage 240A that are executed to, e.g., lookup values of the header to determine a new value for header field X, write header field X, etc., are replaced with a simplified operation stored in operation database 246. Packet processing thread(s) 248 apply the simplified operations stored in operation database 246 to subsequent packets of the packet flow in lieu of packet processing module 222 processing those subsequent packets using the full pipeline 239. In this way, the techniques reduce the amount of instructions required to be executed.

As another example of reducing or consolidating instructions, operation list creator 242 may determine packet operations associated with a flow that are reduced or condensed in comparison to packet operations performed by packet learning thread 238. Operation list creator 242 may analyze packet operations performed by packet learning thread 238 and determine packet operations that are reduced or condensed in one or more ways, such as by combing packet operations, excluding packet operations, and/or other ways. Operation list creator 242 may determine one or more of processing stages 240 that may be skipped in processing a packet associated with a given flow. In an example, operation list creator 242 determines at least one of processing stages 240 for which the packet learning thread 238 excludes an associated packet operation from application to the first packet and excludes a packet operation associated with the at least one of processing stages 240 in the packet operations stored to operation database 246. For instance, processing stage 240B may not affect the forwarding or state of a packet, in which case an operation for processing stage 240B may not be included in operation database 246 for the associated packet flow.

Packet processing module 222 includes one or more of packet processing threads 248, which may be software components configured to apply packet operations to packets. Packet processing module 222 may use packet processing threads 248 to apply packet operations of operation database 246 to packets of packet flows, such as packet 233. In some cases, packet processing module 222 use a packet processing thread specific to a particular packet flow to process packets associated with that packet flow. In an example, flow check module 236 receives an indication that packet 233 is associated with a packet for which packet operations have been learned. Packet processing module 222 uses an instance of packet processing threads 248 to execute the packet operations associated with the packet flow of packet 233.

Packet processing threads 248 include operation application module 250, which may be a software component configured to obtain and apply packet operations from operation database 246. In an example, packet processing module 222 retrieves packet operations for a packet flow from operation database 246. Packet processing module 222 uses packet processing thread 248 to implement the packet operations and configures operation application module 250 to apply the packet operations associated with the packet flow. In another example, operation application module 250 reads operations from operation database 246.

Packet processing threads 248 include operation list module 252, which may be a software component of packet processing module 222 configured to manage the packet operations applied by operation application module 250. Operation list module 252 may determine whether the packet operations associated with a packet flow are complete with respect to packet 233 being processed. In some examples, operation list module 252 may obtain the packet operations from operation database 246 and orchestrate the application of packet operations by operation application module 250 and/or terminal packet processing module 254.

Terminal processing packet processing module 254 may be a software component of packet processing module 222 configured to apply packet operations. Packet processing module 222 may configure terminal packet processing module 254 to apply a terminal or final packet operation of packet operations associated with a packet flow. For example, terminal packet processing module 254 may provide packet 233 to a network interface for egress.

In some examples, packet processing module 222 may use the same CPU execution thread for both processing packets using a full set of processing stages 240 and processing packets using reduced packet operations, based on flow affinities. Packet processing module 222 may use flow affinities that are associations packet flows to compute resources to bind packet flows to the compute resources (e.g., processor cores and corresponding execution threads). Packet processing module 222 may use these flow affinities to determine with which packet processing thread to process a packet, where some packet flows are not selected for packet operation packet processing module 222 receives packet 233. For example, packet processing module 222 may process packet 233 using packet learning thread 238 based on determining that the operations for packet 233 have not yet been learned. Packet processing module 222 may store data associating the packet flow for packet 233 to the CPU resource executing the packet learning thread 238 to bind the packet flow to that CPU resource. For a subsequent packets associated with the same packet flow as packet 233, packet processing module 222 processes the subsequent packets using the same thread but executing the reduced packet path implementing packet operations retrieved from operation database 246 (as illustrated by and described elsewhere with respect to packet processing thread(s) 248).

Packet processing module 222 may in this way provide one or more improvements in processing packets. For example, packet processing module 222 may:
uniquely identify traffic patterns for operation reduction;
use memory over CPU for optimizing packet pipeline by choosing any CPU thread for learning and fast processing;
may enable any software-driven packet pipeline to adopt this optimization model for packet processing;
select packets to be subjected to packet operation leaning and the rest of the traffic to run as is; and/or
adopt new packet pipelines that can grow or shrink as the network changes.

In another example, packet processing module 222 may provide an improvement through use of a well-refined flow definition as described above coupled with optimized packet operations list to enable predicable performance for the virtual network device that includes packet processing module 222, irrespective of the environment (e.g., on premises, public cloud, etc.) to which virtual network device is deployed. An orchestrator may deploy a virtual network device that included packet processing module 222 using Helm charts (e.g., such as those included in deployment data 221). Packet processing module 222 may use the definition of flows as derived from the Helm chart so that the learning of packet path is tailored to that deployment.

In an example of the techniques, a virtual network device executing packet processing module 222 receives a first UDP packet associated with a UDP packet flow. Packet processing module 222 processes the first UDP packet using packet learning thread 238 and, while performing a series of operations in a series of stages 240, observes information regarding modifications to the first UDP packet, an outcome for the first UDP packet (e.g., drop, forward), and any system operations (e.g., counting). The virtual network device receives a second UDP packet associated with the same UDP packet flow and processes the second UDP packet using one of packet processing threads 248 configured with only the operations generated based on the observed information regarding modifications, outcome, and system operations used to process the first UDP packet (e.g., rather than by fully executing stages 240 using a typical packet processing thread).

Packet processing module 222 enable improvements in learning packet operations. For instance:
Each system may use different packet forwarding engines (e.g., representing/simulating ASICs) and result in the need for different processes to capture information. For example, server 12A of FIG. 1 may use simulated silicon for packet processing. In such an example, server 12A may require a packet path with user-created locations in the simulation to learn operations applied to the packet. Packet processing module 222 may implement learning functionality which is built into the simulator. In addition, a fully software-driven packet forwarding pipeline, such as one implemented by packet processing module 222, may not require such functionality as learning may not require use of the user-created model for the simulated silicon.
Packet processing module 222 may define stages in packet path, which enables the learning of packet operations to be generic and adaptive. Packet processing module 222 may utilize a software-driven packet forwarding pipeline where packet path is split into logical stages and that can be changed as the packet path changes. Packet processing module 222 may expand and shrink with the pipeline making it generic unlike other optimization models.

Packet processing module 222 may enable flexibility in selecting memory over CPU/number of threads. For instance:
Traditional packet processing systems may elect to have a fixed thread for learning and fixed threads for packet processing.
Packet processing module 222 may choose any thread for learning and any thread for fast processing as the selection of packet for optimization is user driven.

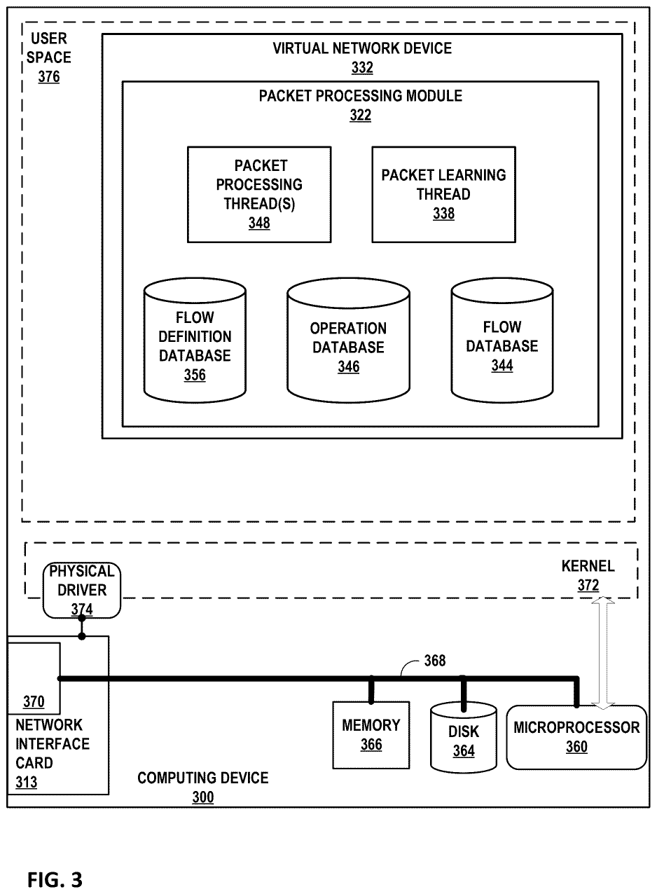

FIG. 3 is a block diagram of an example computing device 300 that implements packet processing, in accordance with one or more aspects of this disclosure. Computing device 300 may represent a real or virtual server and may represent an example instance of any of servers 12 of FIG. 1.

Computing device 300 includes in this example, a bus 368 coupling hardware components of a computing device 300 hardware environment. Bus 368 couples network interface card (NIC) 313, storage disk 364, and one or more microprocessors 360 (hereinafter, “microprocessor 360”). NIC 313 may be SR-IOV-capable. In some examples, NIC 313 may be an instance of NICs 13 as illustrated in FIG. 1. A front-side bus may in some cases couple microprocessor 360 and memory device 366. In some examples, bus 368 may couple memory device 366, microprocessor 360, and NIC 313. Bus 368 may represent a Peripheral Component Interface (PCI) express (PCIe) bus. In some examples, a direct memory access (DMA) controller may control DMA transfers among components coupled to bus 368. In some examples, components coupled to bus 368 control DMA transfers among components coupled to bus 368.

Microprocessor 360 may include one or more processors each including an independent execution unit to perform instructions that conform to an instruction set architecture, the instructions stored to storage media. Execution units may be implemented as separate integrated circuits (ICs) or may be combined within one or more multi-core processors (or “many-core” processors) that are each implemented using a single IC (i.e., a chip multiprocessor). Each execution unit can execute one thread at a time.

Disk 364 represents computer readable storage media that includes volatile and/or non-volatile, removable and/or non-removable media implemented in any method or technology for storage of information such as processor-readable instructions, data structures, program modules, or other data. Computer readable storage media includes, but is not limited to, random access memory (RAM), read-only memory (ROM), EEPROM, Flash memory, CD-ROM, digital versatile discs (DVD) or other optical storage, magnetic cassettes, magnetic tape, magnetic disk storage or other magnetic storage devices, or any other medium that can be used to store the desired information and that can be accessed by microprocessor 360.

Main memory 366 includes one or more computer-readable storage media, which may include random-access memory (RAM) such as various forms of dynamic RAM (DRAM), e.g., DDR2/DDR3 SDRAM, or static RAM (SRAM), flash memory, or any other form of fixed or removable storage medium that can be used to carry or store desired program code and program data in the form of instructions or data structures and that can be accessed by a computer. Main memory 366 provides a physical address space composed of addressable memory locations.

Network interface card (NIC) 313 includes one or more interfaces 370 configured to exchange packets using links of an underlying physical network. Interfaces 370 may include a port interface card having one or more network ports. NIC 313 may also include an on-card memory to, e.g., store packet data. Direct memory access transfers between the NIC 313 and other devices coupled to bus 368 may read/write from/to the NIC memory.

Memory 366, NIC 313, storage disk 364, and microprocessor 360 may provide an operating environment for a software stack that includes an operating system kernel 372 executing in kernel space. Kernel 372 may represent, for example, a Linux, Berkeley Software Distribution (BSD), another Unix-variant kernel, or a Windows server operating system kernel, available from Microsoft Corp. In some instances, the operating system may execute a hypervisor and one or more virtual machines managed by hypervisor. Example hypervisors include Kernel-based Virtual Machine (KVM) for the Linux kernel, Xen, ESXi available from VMware, Windows Hyper-V available from Microsoft, and other open-source and proprietary hypervisors. The term hypervisor can encompass a virtual machine manager (VMM). An operating system that includes kernel 372 provides an execution environment for one or more processes in user space 376.

Kernel 372 includes a physical driver 374 to use the network interface card 313. Network interface card 313 may also implement SR-IOV to enable sharing the physical network function (I/O) among one or more virtual execution elements, such as containers or one or more virtual machines (not shown in FIG. 3). Shared virtual devices such as virtual functions may provide dedicated resources such that each of the virtual execution elements may access dedicated resources of NIC 313, which therefore appears to each of the virtual execution elements as a dedicated NIC. Virtual functions may represent lightweight PCIe functions that share physical resources with a physical function used by physical driver 374 and with other virtual functions. For an SR-IOV-capable NIC 313, NIC 313 may have thousands of available virtual functions according to the SR-IOV standard, but for I/O-intensive applications the number of configured virtual functions is typically much smaller.

Virtual network device 332, which may be a software component of computing device 300. While illustrated as executed within user space 376, virtual network device 32 may execute within kernel 372 in some examples. Executable instructions for virtual network 332 may be stored in disk 364. Virtual network device 332 may be an instance of virtual network device 32 as illustrated in FIG. 1. For example, virtual network device 332 may process packets received via interfaces 370 of NIC 313.

Virtual network device 32 includes packet processing module 322, which may be a software component of computing device 300 configured to process packets. Packet processing module 322 may be an instance of packet processing module 22 as illustrated in FIG. 1 and/or packet processing module 222 as illustrated in FIG. 2. For instance, packet processing module may process packets received by computing device 300 using packet learning thread 338 and/or packet processing threads 348.

Packet processing module 322 includes packet learning thread 338, which may be a packet processing thread or pipeline configured to process packets. Packet learning thread 338 may implement a plurality of packet processing stages that each apply a packet operation. Packet processing module 322 may observe packet operations performed by packet learning thread 338 and store the operations in operation database 346. In an example, packet processing module 322 receives a packet associated with a packet flow. Packet processing module 322 determines that packet operations for the packet flow are not stored in operation database 346 and processes the packet using packet learning thread 338. Packet processing module 322 observes the packet operations applied by packet learning thread 338 and stores the packet operations in operation database 346.

Packet processing module 322 includes operation database 346, which may be a datastore configured to store packet operations. Packet processing module 322 may store packet operations in operation database 346 in association with particular packet flows to which the packet operations apply. For example, packet processing module 322 may store packet operations associated with a packet flow in a table of packet operations.

Packet processing module 322 includes one or more packet processing threads 348, which may be software components of computing device 300 configured to process packets. Packet processing module 322 may instantiate instances of packet processing threads 348 to apply packet operations associated with packet flows. For example, packet processing module 322 may instantiate an instance of packet processing threads 348 to apply packet operations associated with a packet flow and retrieved from operation database 346.

Packet processing module 322 includes flow database 344, which may be a datastore configured to store packet flow identifiers. Packet processing module 322 may store packet flow identifiers in flow database 344 for use in identifying packets for processing by packet processing threads 348. Packet processing module 322 may use the packet flow identifiers stored in flow database 344 in one or more ways, such as determining whether to process a packet using packet processing threads 348 or packet learning thread 338, determining whether a packet flow has been observed by packet processing module 322, and/or in other ways.

Packet processing module 322 includes flow definition database 356, which may be a datastore configured to store definitions of packet flows. Packet processing module 322 may obtain definitions of packet flows in one or more ways, such as processing Helm charts or other configuration objects used to configure a network, observing packet flows processed by packet processing module 322, and/or in other ways. In an example, packet processing module 322 obtains a configuration mapping of a network pushed by a network orchestrator and processes the configuration mapping to determine definitions of packet flows of the network. Packet processing module 322 stores the definitions in flow definition database 356.

Packet processing module 322 may store user selections of packet flows in flow definition database. Packet processing module 322 may enable a user to select packet flows for reduction in packet operations in one or more ways, such as selecting flows defined by a Helm chart. Packet processing module 322 may use the user selection of packet flows to select packet flows for reduction in packet operations.

Packet processing module 322 may determine packet operations for a packet flow in response to determining that the packet flow has changed. Packet processing module 322 may determine a change in a packet flow in one or more ways, such as determining that a flow definition has changed, that one or more fields of incoming packets have changed, and/or based on other factors. Based on determining that a packet flow has changed, packet processing module 322 may route an incoming packet associated with the flow to packet learning thread 338 to learn operations applied to the incoming packet. In an example, packet processing module 322 determines a change in a packet flow after processing first and second packets associated with the packet flow. Packet processing module 322 receives a third packet and determines packet operations for the packet flow based on packet operations applied to the third packet.

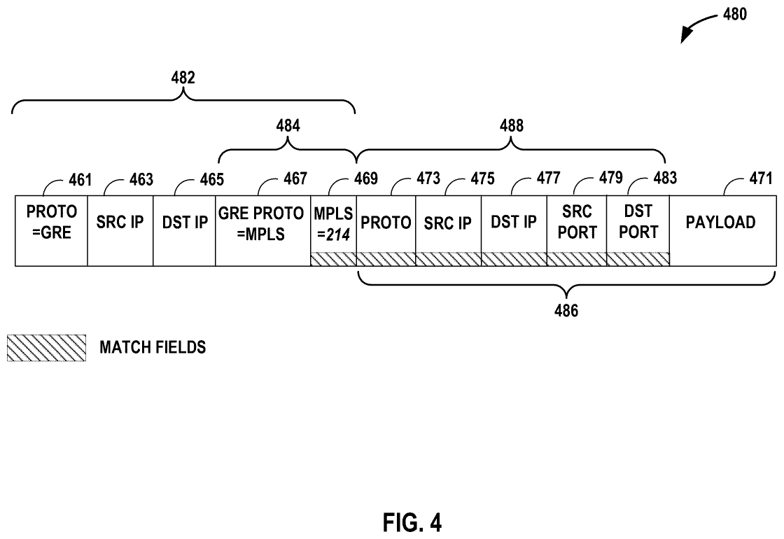

FIG. 4 is a block diagram of an example packet 480 that may be processed by a computing device, in accordance with one or more aspects of this disclosure. For simplicity and ease of illustration, packet 480 does not illustrate each and every field of a typical tunnel packet but is offered to highlight the techniques described herein. In addition, various implementations may include tunnel packet fields in various orderings. FIG. 4 is described in the context of FIG. 1.

“Outer” or “tunnel” packet 482 includes outer header 482 and inner or “encapsulated” packet 486. Outer header 482 may include protocol or type-of-service (TOS) field 461 and public (i.e., switchable by the underling physical network for a virtual network associated with inner packet 486) IP address information in the form of source IP address field 463 and destination IP address field 465. Protocol field 461 in this example indicates tunnel packet 480 uses GRE tunnel encapsulation, but other forms of tunnel encapsulation may be used in other cases, including IPinIP, NVGRE, VxLAN, and MPLS over MPLS, for instance.

Outer header 482 also includes tunnel encapsulation 484, which in this example includes GRE protocol field 467 to specify the GRE protocol (here, MPLS) and MPLS label field 469 to specify the MPLS label value (here, 214). The MPLS label field is an example of a virtual network identifier and may be associated in a virtual router with a routing instance for a virtual network.

Inner packet 486 includes inner header 488 and payload 471. Inner header 488 may include protocol or type-of-service (TOS) field 473 as well as private (i.e., for a particular virtual routing and forwarding instance) IP address information in the form of source IP address field 475 and destination IP address field 477, along with transport layer information in the form of source port field 479 and destination port field 483. Payload 471 may include application layer (layer 7 (L7)) and in some cases other L4-L7 information produced by or for consumption by a virtual machine for the virtual network. Payload 471 may include and thus alternatively be referred to as an “L4 packet,” “UDP packet,” or “TCP packet.”

In accordance with techniques described in this disclosure, a virtual network device 32A processes packet 480 using packet processing module 22A. Packet processing module 22A may apply packet operations to packet 480 to modify one or more of the fields of packet 480. Packet processing module 22A may apply a packet operation to packet 480. Packet processing module 22A may apply a system operation based on packet 480.

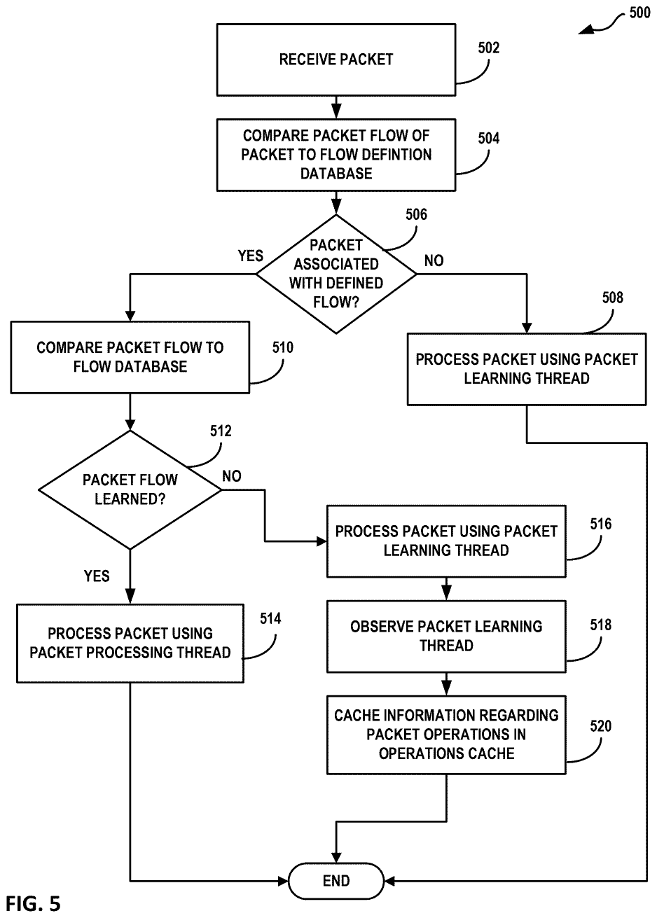

FIG. 5 is a flowchart illustrating example operations for applying packet processing, in accordance with one or more aspects of this disclosure. FIG. 5 is described in the context of FIG. 2.

Packet processing module 222 receives a packet (502). Packet processing module 222 may receive a packet, such as packet 233, via an interface of a server executing a virtual network device that includes packet processing module 222. For example, the virtual network device may receive packet 233, where packet 233 is associated with a packet flow, and provide the packet to packet processing module 222 for processing.

Packet processing module 222 compares the packet flow associated with packet 233 to a flow definition database, such as flow definition database 256 (504). Packet processing module 222 may compare the packet flow to a flow definition stored in flow definition database 256 to determine whether the packet flow associated with packet 233 has been selected. In an example, packet processing module 222 determines which packet flow is associated with packet 233. Flow check module 236 compares the determined packet flow to packet flow definitions stored in flow definition database 256 to determine whether the packet flow of packet 233 is a selected packet flow.

Based on determining that the packet flow of the received packet is not associated with a defined packet flow (NO branch of 506), packet processing module 222 processes packet 233 using packet learning thread 238 or other packet processing thread configured to implement a packet processing pipeline (508). In other words, packet processing module 222 processes the packet normally, i.e., using a packet processing pipeline that implements packet processing stages without reduction or compression of packet operations applied to the received packet.

Based on determining that the packet flow of packet 233 is associated with a defined flow in flow definition database 256 (YES branch of 506), packet processing module 222 compares the packet flow to flow database 244 (510). Packet processing module 222 may use flow check module 236 to determine whether flow database 244 includes an entry for the packet flow indicating that packet operations have been learned for the packet flow. In an example, flow check module 236 compares a hash value for the received packet to flow database 244. Flow check module 236 determines that flow database includes an entry for the packet flow associated with packet 233 to determine that packet 233 should be processed using cached packet operations.

Based on determining that flow database 244 includes an entry for the packet flow (YES branch of 512), packet processing module 222 processes packet 233 using one of packet processing threads 248 configured to apply the learned packet operations. Packet processing module 222 may retrieve packet operations from a database, such as operation database 246, and cause one of packet processing threads 248 to apply the packet operations retrieved from operation database 246. In an example, packet processing module 222 obtains known packet operations for a packet flow from operation database 246 and causes an instance of packet processing threads 248 to apply the packet operations.

Based on determining that packet operations for the packet flow have not been learned (NO branch of 512), packet processing module 222 processes packet 233 using packet learning thread 238 (516). Packet processing module 222 may process the packet learning thread 238 to observe the packet operations applied to packet 233 associated with the packet flow. For instance, packet processing module 222 may process packet 233 using an instance of packet learning thread 238 configured to implement processing stages 240 regardless of whether individual processing stages apply a packet operation to the packet.

Packet processing module 222 observes packet learning thread 238 (518). Packet processing module may use operation list creator 242 to observe packet learning thread 238 as packet learning thread 238 processes the packet through pipeline 239 using processing stages 240. Operation list creator 242 may observe the processing of the packet by packet learning thread 238 and determine the packet operations applied at each of processing stages 240 to packet 233.

Packet processing module 222 caches information regarding processing of packet 233 in operation database 246 (520). The information regarding processing of packet 233 may include indications of the packet operations applied to packets associated with the packet flow. These packet operations may be reduced or condensed, as described above. Operation list creator 242 may store the packet operations in operation database 246 as “known” or “learned” packet operations for the packet flow. In an example, operation list creator 242 determines packet operations applied to packet 233 by packet learning thread 238 and stores the determined packet operations in operation database 246. In some examples, packet processing module 222 may determine reduced packet operations and store the reduced packet operations in operations database 246.

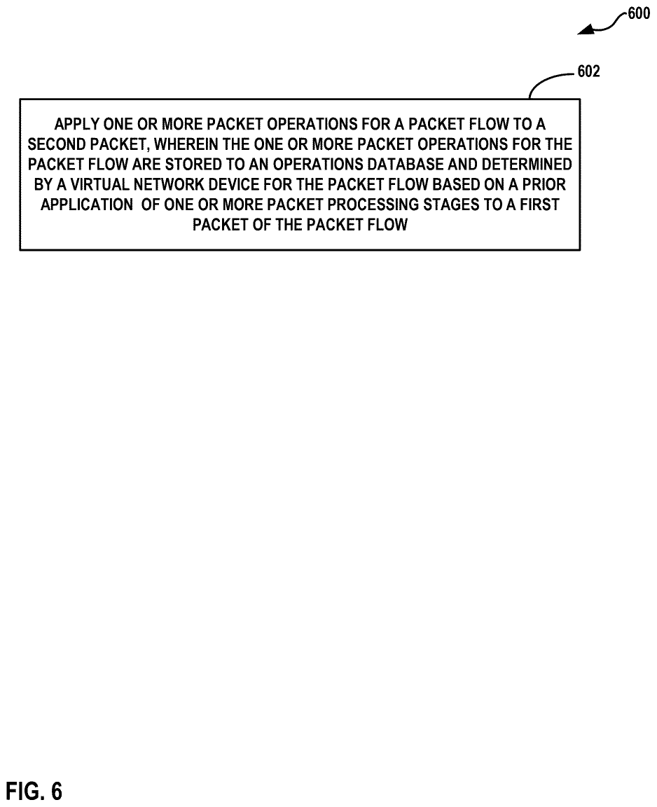

FIG. 6 is a flowchart illustrating an example operation for applying packet operations, in accordance with one or more aspects of this disclosure. FIG. 6 is described in the context of FIG. 1.

A virtual network device, such as virtual network device 32, applies one or more packet operations for a packet flow to a second packet, where the one or more packet operations for the packet flow are stored to an operations database and determined by virtual network device 32 for the packet flow based on a prior application of one or more packet processing stages to a first packet of the packet flow (602). Virtual network device 32 may store the packet operations in an operations database or cache in association with an identifier of the flow. Virtual network device 32 may use a packet learning thread to determine the one or more packet operations applied to the first packet. In some examples, virtual network device 32 may determine packet operations that may be combined as part of determining the packet operations applied to the first packet.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A computing device comprising:
memory;
processing circuitry in communication with the memory; and
a virtual network device executed by the processing circuitry and configured to:
based on a determination that a second packet received by the virtual network device is associated with a packet flow, apply one or more packet operations for the packet flow to the second packet, wherein the one or more packet operations for the packet flow are stored to an operations database and determined by the virtual network device for the packet flow based on a prior application, by the virtual network device, of one or more packet processing stages to a first packet of the packet flow.

2. The computing device of claim 1, wherein the virtual network device is further configured to:
receive the first packet prior to receiving the second packet;
process the first packet using the one or more packet processing stages;
determine the one or more packet operations based on the one or more packet processing stages used to process the first packet; and
store the one or more packet operations for the packet flow to the operations database.

3. The computing device of claim 2, wherein to determine the one or more packet operations for the packet flow, the virtual network device is configured to determine, based on an indication of user selection of the packet flow, the one or more packet operations for the packet flow.

4. The computing device of claim 2, wherein to determine the one or more packet operations for the packet flow, the virtual network device is configured to:
determine at least one packet processing stage of the one or more packet processing stages for which the virtual network device refrains from applying a packet operation to the first packet; and
excluding a packet operation associated with the at least one packet processing stage in the packet operations stored to the operations database.

5. The computing device of claim 1,
wherein the memory includes the operations database that stores the indication of the one or more packet operations, and
wherein the virtual network device is configured to retrieve an indication of the one or more packet operations from the operations database.

6. The computing device of claim 1,
wherein the virtual network device executes a first packet processing thread to process the first packet, and
wherein to apply the one or more packet operations, the virtual network device is configured to instantiate a second packet processing thread configured to apply the one or packet processing operations.

7. The computing device of claim 6, wherein the virtual network device is further configured to:
determine a condensed packet processing operation that is a combination at least two of the one or more packet processing operations performed by the first packet processing thread.

8. The computing device of claim 1, wherein the virtual network device is further configured to:
determine, for each packet processing stage of the one or more packet processing stages applied to the first packet, an associated packet operation, wherein the associated packet operation is one of forwarding the first packet or dropping the first packet.

9. The computing device of claim 1, wherein the packet flow is a first packet flow, wherein one or more packet operations are one or more first packet operations, wherein the one or more packet processing stages are one or more first packet processing stages, and wherein the virtual network device is further configured to:
based on a determination that a fourth packet received by the virtual network device is associated with a second packet flow, apply one or more second packet operations for the second packet flow to the fourth packet, wherein the one or more second packet operations for the second packet flow are stored to an operations database and determined by the virtual network device for the second packet flow based on a prior application, by the virtual network device, of one or more second packet processing stages to a third packet of the second packet flow.

10. The computing device of claim 1, wherein the virtual network device is further configured to:
determine a change in the packet flow;
receive a third packet; and
determine the one or more packet operations for the packet flow based on packet operations applied to the third packet.

11. A method, comprising:
based on a determination that a second packet received by the virtual network device is associated with a packet flow, apply, by a virtual network device, one or more packet operations for the packet flow to the second packet, wherein the one or more packet operations for the packet flow are stored to an operations database and determined by the virtual network device for the packet flow based on a prior application, by the virtual network device, of one or more packet processing stages to a first packet of the packet flow.

12. The method of claim 11, further comprising:
receiving, by the virtual network device, the first packet prior to receiving the second packet;
applying, by the virtual network device, the one or more packet processing stages to the first packet;
process the first packet using the one or more packet processing stages;
determining, by the virtual network device, the one or more packet operations based on the one or more packet processing stages used to process the first packet; and
storing, by the virtual network device, the one or more packet operations for the packet flow to the operations database.

13. The method of claim 12, wherein determining the one or more packet operations for the packet flow further comprising determining the one or more packet operations for the packet flow based on an indication of user selection of the packet flow.

14. The method of claim 12, wherein determining the one or more packet operations for the packet flow further comprises:
determining, by the virtual network device, at least one packet processing stage of the one or more packet processing stages for which the virtual network device refrains from applying a packet operation to the first packet; and
excluding, by the virtual network device, a packet operation associated with the at least one packet processing stage in the packet operations stored to the operations database.

15. The method of claim 11,
wherein the operations database stores the indication of the one or more packet operations, and
further comprising retrieving an indication of the one or more packet operations from the operations cache.

16. The method of claim 11,
wherein the virtual network device executes a first packet processing thread to process the first packet,
and wherein applying the one or more packet operations further comprises:
instantiating a second packet processing thread configured to apply the one or packet processing operations.

17. The method of claim 16, further comprising:
determining, by the virtual network device, a condensed packet processing operation that is a combination at least two of the one or more packet processing operations performed by the first packet processing thread.

18. The method of claim 11, further comprising:
determine, by the virtual network device and for each packet processing stage of the one or more packet processing stages applied to the first packet, an associated packet operation, wherein the associated packet operation is one of forwarding the first packet or dropping the first packet.

19. The method of claim 11, wherein the packet flow is a first packet flow, wherein one or more packet operations are one or more first packet operations, wherein the one or more packet processing stages are one or more first packet processing stages, and further comprising:
based on a determination that a fourth packet received by the virtual network device is associated with a second packet flow, applying, by the virtual network device, one or more second packet operations for the second packet flow to the fourth packet, wherein the one or more second packet operations for the second packet flow are stored to an operations database and determined by the virtual network device for the second packet flow based on a prior application, by the virtual network device, of one or more second packet processing stages to a third packet of the second packet flow.

20. Non-transitory computer-readable media configured with instructions that, when executed, cause processing circuitry to:
based on a determination that a second packet received by the virtual network device is associated with a packet flow, apply one or more packet operations for the packet flow to the second packet, wherein the one or more packet operations for the packet flow are stored to an operations database and determined by the virtual network device for the packet flow based on a prior application, by a virtual network device, of one or more packet processing stages to a first packet of the packet flow.
